(19) United States
(12) Patent Application Publication
(10) Pub. No.: US 2014/0172571 A1
(43) Pub. Date: Jun. 19, 2014

(54) SELECTING CONTENT ITEMS BASED ON GEOPOSITIONING SAMPLES

(71) Applicant: Google Inc., (US)

(72) Inventors: Alexander Fabrikant, Palo Alto, CA (US); Yaron Singer, Berkeley, CA (US); Michael Bachman, Sunnyvale, CA (US)

(73) Assignee: Google Inc., Mountain View, CA (US)

(21) Appl. No.: 13/719,807

(22) Filed: Dec. 19, 2012

(51) Int. Cl. H04L 12/26

(52) U.S. Cl. CPC H04L 43/00; G06Q 30/0261
USPC 705/14.58; 709/224

(57) ABSTRACT

Apparatus and method for identifying a geographical route along which a network accessible device is repetitively moved. In accordance with some embodiments, a sequence of geopositioning samples from a network accessible device is received, the samples indicative of different geographical locations of the device over a time interval. A geographical route is identified along which the device was repetitively moved from the sequence of samples. A content item is selected for an entity having a physical location proximate the geographical route. The content item is displayed on a display associated with a user of the network accessible device.

### BACKGROUND

Content providers (“publishers”) generally provide content for display on various network accessible devices (e.g., smart phones, tablets, laptops, e-readers, desktop computers, etc.). The content can take a variety of forms, such as web pages, mobile applications (apps), audio works (e.g., mp3 files), video works, textual works (e.g., e-books), etc. The publisher content is often accompanied by content items (such as advertisements, other promotional messages, communications, etc.) that can take a variety of forms, including text, image, video, rich media, etc.

The publisher content can be arranged to request and display one or more content items in specially configured slots within or on the publisher display. The content items may establish links to landing pages or other publisher content owned by third parties. The display of content items can provide a number of benefits to the publisher, such as revenue opportunities when the user of the device views or selects a content item.

### SUMMARY

Various embodiments disclosed herein are generally directed to an apparatus and method for identifying a geographical route along which a network accessible device is repetitively moved.

In accordance with some embodiments, a sequence of geopositioning samples from a network accessible device is received, the samples indicative of different geographical locations of the device over a time interval. A geographical route is identified along which the device was repetitively moved from the sequence of samples. A content item is selected for an entity having a physical location proximate the geographical route. The content item is displayed on a display associated with a user of the network accessible device.

These and other features and advantages which may characterize various embodiments can be understood in view of the following detailed discussion and the accompanying drawings.

### BRIEF DESCRIPTION OF THE DRAWINGS

FIG. 1 provides a functional block representation of a network-based system in accordance with various embodiments.

FIG. 2 provides another functional block representation of the network-based system in accordance with various embodiments.

FIG. 3 shows aspects of the system of FIGS. 1 and 2 in accordance with some embodiments.

FIG. 4 provides a plurality of geopositioning samples from a plurality of geographical routes in accordance with various embodiments.

FIG. 5 depicts a table of frequency count information associated with the routes of FIG. 4.

FIG. 6 is a graphical representation of acceleration data in accordance with various embodiments.

FIG. 7 shows aspects of a user model engine in accordance with some embodiments.

FIG. 8 is a flow chart for a geopositioning sampling routine generally illustrative of steps carried out in accordance with some embodiments.

FIG. 9 is a flow chart for a content item generation routine generally illustrative of steps carried out in accordance with some embodiments.

FIG. 10 is a flow chart for a content item selection routine generally illustrative of steps carried out in accordance with some embodiments.

### DETAILED DESCRIPTION

The present disclosure generally relates to providing content items for display with publisher content on a network accessible device, such as but not limited to a mobile communication device or a desktop computer.

Publisher display items are often stored on or transferred to a network accessible device for presentation via a graphical user interface (GUI) of the device. Publisher display items may take a variety of forms, such as but not limited to web pages, mobile applications (apps), e-reader books, email services, search engines, games, audio works, video works, etc.

A publisher display item may include content supplied by the publisher as well as one or more slots to accommodate the insertion of content item(s) from third parties. The content items may be selected from a population of available content items from various content item providers. The content items can take a variety of forms, such as advertisements, communications, public service announcements, invitations to participate in a survey, petition, or some other activity, etc.

Content items can include a creative portion and an interactive portion. The creative portion may provide textual, audio, image and/or video information to the user. The interactive portion, when selected (such as being “clicked”) by the user, may alter the display by connecting the device to a linked web page or other location (“landing page”) associated with the creative portion.

It is becoming increasingly desirable for content owners, such as advertisers, to serve content items to network accessible devices of individuals that are likely to respond favorably to the presentation of the content items, such as by purchasing products and/or services or by visiting certain physical locations associated with the displayed content items.

Accordingly, various embodiments of the present disclosure generally operate to display content items in relation to geographical travel patterns associated with a network accessible device. As explained below, when a user of a network accessible device elects to share geopositioning information associated with the device, geopositioning samples from the device are used to identify one or more geographical routes along which the device was repetitively moved over a selected time interval. One or more content items are thereafter selected and transferred for display on a display device associated with the user in relation to the detected geographical routes. Content items from entities having physical locations proximate the geographical route may be selected for display.

In some embodiments, the content items are directly displayed on the network accessible device, which may be a smart phone or other mobile communication device which can be carried by the user. In other embodiments, the content items are displayed on a different device associated with the user, such as a desktop computer, tablet, e-reader, etc. The different device may be located proximate an end point of a selected route taken by the user.

The routes may be selected based on frequency of the various travel patterns; that is, the number of times the route is taken over the associated interval. Only those routes that are travelled at least a threshold number N times during the time interval may be selected for consideration. Alternatively, a relative measure of the respective route frequencies is used, so that the content items are selected in relation to route(s) having a relatively higher travel frequency.

In other embodiments, a model is formulated based on the geographical route data generally indicative of one or more characteristics of the travel patterns of the user. The model may be based on acceleration data associated with the geographical route, and/or on other data such as map data, weather data, etc. One or more content items may be provided for display on a display device associated with the user responsive to the generated model.

Bids, which represent an amount an entity may be willing to pay for display of an associated content item, may be submitted with or generated in conjunction with the content items. The bids may vary based on the geographical routes. For example, some entities may provide higher bids for higher route frequencies, different model characteristics, detected changes in geographical route taken as a result of the display of the content item, etc.

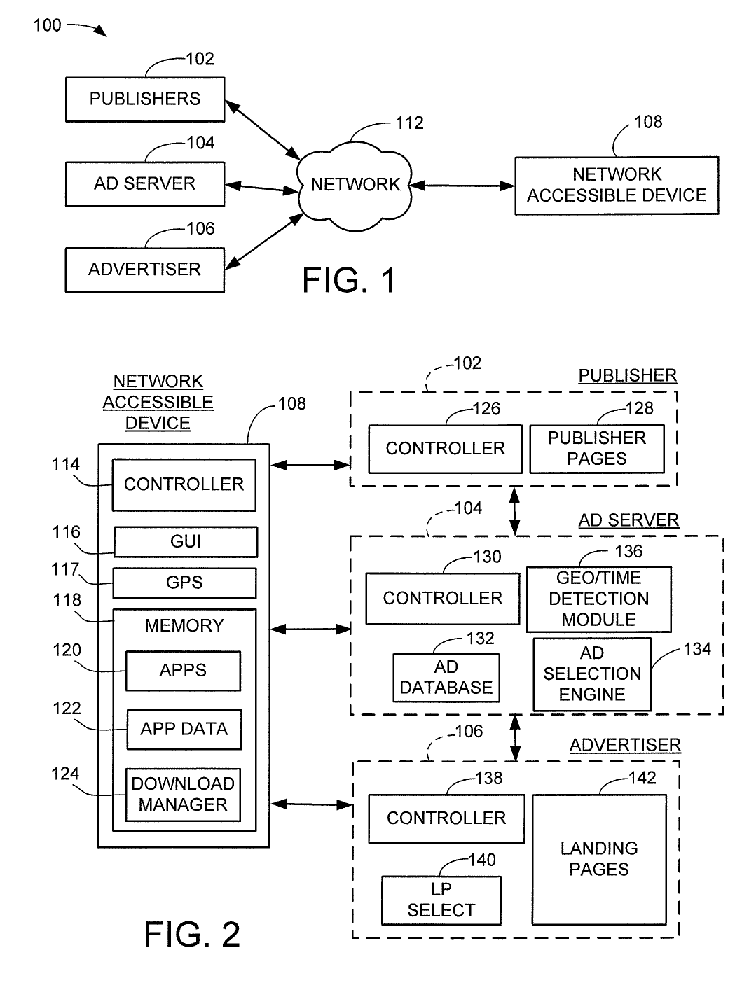

These and other features and benefits of the present disclosure can be understood beginning with a review of FIG. 1, which depicts a network-based data transfer system 100 constructed and operated in accordance with various embodiments.

For purposes of providing a concrete example, the content items served by the system 100 will be contemplated as comprising advertisements (ads) which are displayed in various ad slots in different types of publisher display items. It will be appreciated that this is merely for purposes of providing a concrete example and is not limiting, as the system can be configured to provide any number of different types of content items as desired.

The system 100 incorporates a number of active elements including publisher servers 102, an advertisement (ad) server 104, an advertiser (content item owner) server 106, and at least one user network accessible device 108, all of which communicate over one or more network 112.

The various servers and devices in FIG. 1 communicate via a network fabric 112, which may constitute one or more communication networks such as the Internet, a WAN (wide area network), a LAN (local area network), a broadband wireless (wifi) network, etc.

The publishers 102 represent hosting servers or similar systems adapted to transfer a variety of different types of publisher content to the device 108, such as web pages, mobile apps, search engines, communication programs, A/V works, etc. The ad server 104 services ad requests to display ads in conjunction with the publisher content. The advertiser server 106 can be associated with a source or owner of the goods or services associated with the ads supplied by the ad server.

The network accessible device 108 can take a variety of forms, such as a desktop computer, a laptop computer, a smart phone, a tablet, a gaming console, a television, an electronic reader (e-reader), or other similar device adapted to interact with the publisher 102, ad server 104 and advertiser 106. It will be appreciated that other elements may be incorporated into the system 100 as desired.

FIG. 2 shows aspects of the system 100 of FIG. 1 in accordance with some embodiments. The network accessible device 108 from FIG. 1 will be contemplated to be a mobile communication device such as a smart phone, although this is merely for purposes of providing a concrete example and is not limiting.

The device 108 includes a controller 114, a graphical user interface (GUI) 116, a global positioning system (GPS) 117 and memory 118. The controller 114 may be a programmable processor that uses associated operating system programming and application software (e.g., a web browser) in the memory to interact with the network 112.

The GUI 116 may include a display monitor, keyboard, mouse, speakers, headphones, a touch screen, etc. The memory 118 may represent a hierarchical memory structure made up of various memory devices within the user device 108, including such elements as a non-volatile main memory (e.g., disc memory, solid-state drive, etc.), data transfer buffer, local processor (L1-L3) cache, etc.

The memory 118 stores various operational modules including applications (apps) 120 and application (app) data 122. A device operating system (OS), not separately designated, may provide an operational environment for the execution of the apps and use of the data. A download manager 124 operates to control communications and data transfers across the network 112, and may form a portion of the OS.

A selected publisher server 102 may include a controller 126 and a memory which stores a number of available publisher display items 128. In the case of a publisher website, web pages are transferred from the memory 128 responsive to requests from the device 108.

The ad server 104 includes a controller 130, an ad database 132 in associated memory for storing a population of available content items from content providers, an ad selection engine 134 (or content item selection engine) and a geo/time detection module 136. The ad selection engine 134 may be realized as a processor routine stored in the memory and executed by the controller 130, or may be a separate hardware or software module (including a remote module). The ad selection engine 134 generally operates to transfer one or more ads from the database 132 for display on the device 108 in response to ad requests from web pages and other publisher content loaded to or resident on the device 108.

Continuing with FIG. 2, the advertiser server 106 is a type of publisher server for an entity associated with at least one of the content items (ads) in the ad server 104. The advertiser server 106 includes a controller 138, a landing page selector 140 and a set of landing pages 142 in associated memory. The landing page selector 140 selects which landing page is displayer from the set of landing pages when a displayed content item is “clicked” by the user. The associated landing page will depend on the arrangement of the content item and may include without limitation an on-line store, an informational web page, a mechanism whereby an application or other information is downloaded (transferred) to the device, etc. Alternatively, the displayed content resulting from the clicking of the content item on the device 108 may have been initially transferred with the content item and stored in the local memory of the device 118, so that the content is served from the resident memory 118 of the device.

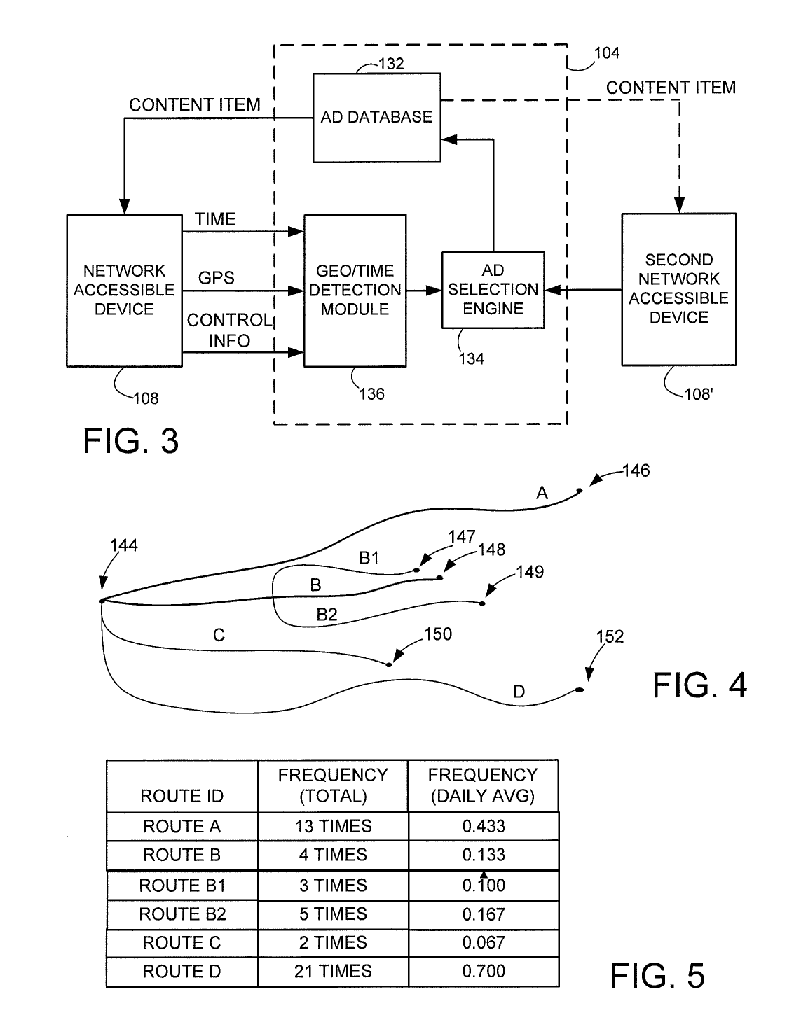

FIG. 3 illustrates aspects of the system 100 in FIGS. 1 and 2 in accordance with some embodiments. The geo/time detector module 136 of the ad server 104 periodically receives time, GPS and control information from the network accessible device 108. Other data inputs can be provided as well. The control information supplied by the network accessible device 108 can be any information relating to usage, content and service parameters of the network accessible device 108.

The geo/time detection module 136 operates to process the received data and provide one or more inputs to the ad selection engine 134, which in turn selects a content item for transfer to and display on the network accessible device 108 based on the inputs from the module 136 and a request from the device 108.

The content item can be transferred while the device 108 is concurrently supplying geopositional samples as generally depicted in FIG. 3. Alternatively, the travel patterns can be generated and maintained by the geo/time detection module 136 for subsequent use. That is, during a later operation of the network accessible device 108, the user can initiate a mobile app or other feature that issues a request as discussed above for the transfer of a content item (e.g., an ad). At this point the ad selection engine 134 can retrieve the travel pattern information from the module 136 and use this information to select an appropriate content item for transfer to the device 108.

It is not necessarily required that the content items be transferred to the same device 108 from which the geopositional samples are derived. FIG. 3 further shows a second network accessible device 108′ associated with the user. The second device 108′ can take a variety of forms, such as an office computer used by the user at a place of employment, a tablet, an e-reader, another smart phone associated with the user, etc. The second device 108′ can be determined to be associated with the user in a variety of ways; the user can specifically identify the device to the network, can log into or otherwise communicate with the system from the second device 108′, or can take other steps such that the second device 108′ is correlated to the first device 108.

During user operation of the second device 108′, an application or other publisher content can request a content item from the ad selection engine 134. As before, the engine 134 can retrieve the travel pattern data from the module 136 and use this data during the content item selection process to transfer an appropriate content item to the second device 108′.

While GPS signals are one form of data that may be used to establish and select the geoposition of the device 108, any number of signals can be used including information derived from cellular communication towers, accelerometer, wifi hotspots, Internet Protocol (IP) addresses, map application information, keyword search information and/or any other information from which the location of the device may be determined. The user of the device is provided the opportunity to control whether programs or features collect such information. Thus, the user controls if and/or how information is collected about the user and used by a content server.

It follows that, for individuals that are willing to share their location, common routes taken by the user (e.g., commuter routes, frequently-traveled roads, etc.) may be determined. This can allow local advertisers to select network accessible devices of users that are based on those routes, thereby ensuring that the ads are served to local consumers.

In one example, a local coffee shop may be located off a main road in city X. The owner of the coffee shop may desire to provide local advertising to network accessible devices of individuals (e.g., both desktop and mobile users) that frequently travel around the coffee shop, such as either directly off the road they are traveling on or those roads in proximity to the coffee shop. As explained below, the coffee shop owner can provide advertisements to network accessible devices of individuals based on frequency (how often they travel those streets), direction, and specific roads in proximate location to the coffee shop. Additionally, advertisements (and other content items) may be provided based on model data associated with the various routes taken by the device. These and other aspects will be discussed in turn.

FIG. 4 generally depicts a number of different geographical routes repetitively taken by a particular network accessible device over a selected time interval. The routes are denoted as Routes A, B, B1, B2, C and D. It will be appreciated that the routes are merely exemplary and can take any variety of forms across a geographical landscape. Portions of the various routes can overlap, such as routes that are taken along highways or common roadways, neighborhood streets, etc. The routes may be automobile routes, public transportation routes, bicycle or walking trails, etc. For simplicity of illustration, each of the example routes is shown to commence at a starting point 144 and terminate at a different end point 146, 147, 148, 149, 150 and 152. However, the routes can be continuous or discontinuous and broken up or combined together as desired.

The Routes A-D are identified from geopositioning samples that are periodically received from the network accessible device 108 as generally depicted in FIG. 3. Each route has an associated frequency, which pertains to how many times the device was detected as travelling along the associated route over the time interval. In some embodiments, a minimum threshold number N (e.g., 2, 5, etc.) of repeated movements along a given route is required before a route is identified. This can help to distinguish between periodic or incidental movements of the device as compared to repeated travel patterns of the device. The threshold can be set at any suitable level (e.g., X times travelled per month/week/day, etc.).

FIG. 5 tabulates the respective routes from FIG. 4 and the associated frequency, or number of times travelled, over an applicable time period (in this case, 30 days). It will be appreciated that the table data are exemplary and do not necessarily reflect all of the detected movements of the device during the applicable interval. While the routes are contemplated as being one-way (e.g., initiating each time from point 144), the system can alternatively select round-trips as well as identify routes in the form of “zones” (e.g., ¼ square mile areas, etc.) within which high frequency travel patterns are concentrated for periods of time.

It can be seen from FIG. 5 that Route D is the most frequently travelled of the identified routes (21 times during the applicable period). Content items may be transferred for entities (e.g., advertisers) located proximate Route D based on the fact that the user is detected as travelling Route D with the greatest frequency. Some routes may be parts of other routes (e.g., route B splits into sub-routes B1 and B2).

If the routes are found to be travelled at different times of day, or different days of the week, however, that information may be used to select appropriate content items based on other detected routes. For example, FIG. 5 shows that Route A was only travelled 13 times over the applicable time period. Providing a content item proximate Route A may be more appropriate if the time at which the content item is served generally corresponds to the travel pattern (e.g., time of day, day of week, etc.) associated with Route A.

Various bands (ranges) of travel pattern frequencies may be defined. For example, using a 30 day (e.g., one month) time interval, daily travelled routes may be routes travelled daily (e.g., 30 or more times during the month); frequently travelled routes may be defines as those travelled 21-29 times during the month; occasionally traveled, 11-20 times/month, seldom traveled, 6-10 times/month, rarely traveled, 1-5 times/month. Other breakdowns can be used as well; for example, a daily average can be calculated for each route, as further shown in FIG. 5, and different frequency ranges assigned to the daily average frequency.

The geopositioning samples may be accumulated over any suitable time intervals, including multiple intervals (e.g., last week, last 30 days, last 90 days, last 180 days, etc.) to determine both short-term and longer-term frequency of travel patterns along various routes.

In further embodiments, entities associated with the content items may provide different bids based on different travel pattern frequencies. Each bid generally represents an amount the entity would be willing to pay for display of the associated content item. The bids may be used by the ad selection engine 134 using an automated auction or other mechanism to select a content item from a population of available content items for display. Generally, the higher the bid, the more likely the content item may be selected by the engine.

An expected return value (ERV) may be determined and used as part of the content item selection process such as in accordance with the following relation:

ERV=(p)(b) (1)

where p represents a probability that the user will select the content item and b represents the bid value. The probability can be established in a variety of ways including based on user interest information supplied by the user. Either or both the probability and the bid value may be a function of the travel pattern frequency associated with various routes.

In further embodiments, some measurement of the route R and the preferences P of the entity associated with the content item may be further incorporated into the content item selection process, such as in accordance with the following relation:

ERV=p(M(R,P)) b(M(R,P))_{—} (2)

where p and b are defined above, and may depend in part on the measurement M(R,P). In some embodiments, M(R,P) can be the distance between a physical location of the entity associated with the content item and the closest point on the route R to that location, which may affect the value of the bid and/or the probability that the user will select the content item. In other embodiments, M(R,P) can be determined by the length of time spent stopped on a highway in a certain region, and the entity associated with the content item, such as a towing service, may provide the associated content item based on the length of time spent stopped in the certain region. As noted above, the content selection process can be carried out as the device 108 is currently determined (via the geoposition samples) to be on a particular route, or can be selected later for display on the device 108, or on another device 108′, based on a previous passage of the device 108 along the route.

An entity may be willing to pay more for the display of a content item on a device for users found to have relatively higher travel pattern frequencies proximate the physical locations associated with the entity. For example, a retailer Y may be willing to pay a premium for display of an advertisement on a user device on the basis that the user (via the detected travel routes) passes by one of the retailer's establishments along a highly travelled route on a regular basis. Because the user presumably sees or is otherwise exposed to the signage of the establishment on a regular basis, the subsequent display of an ad or other content item on a device associated with the user may result in a higher likelihood that the user selects the displayed content item.

Selection of a displayed content item can be detected in a variety of ways. In some embodiments, the content item may be interactive and, upon user selection (such as via a “click”) of the content item, new content is displayed on the device display, such as by directing new content to the device. In this case, the “click” may be a physical selection of the content item on a touch pad or via a mouse or other input device, by shaking or otherwise manipulating the device, by issuing a verbal command to a voice command interface, etc.

In other embodiments, selection of a displayed content item may result from a detected movement of the device 108 to a position toward and/or proximate the physical location of the entity associated with the content item. For example, an ad for the coffee shop discussed above may provide a promotional message offering a free cup of coffee with a purchase. Detecting the device 108 is carried to the coffee shop may suffice to confirm the user selected the displayed content item, regardless whether the user “clicked” the content item on the device.

A selection response interval may be opened after the display of a content item; for example, if a particular content item is displayed, detection of the device 108 moving proximate a physical location of the entity associated with the device within the response interval (e.g., 1 hour, 24 hours, etc.) may be sufficient to characterize the content item as having been selected by the user. Deviation from a current route responsive to the display of a content item in a direction toward a physical location of the entity associated with the content item may also be identified as a selection of the content item. Detection of a local wifi hotspot at the physical location on the device may also be used to determine a selection. These and other alternatives will readily occur to the skilled artisan in view of the present disclosure.

Selection of a displayed content item by the user, in whatever form, may result in a conversion, which will include a transfer of an amount of funds from the entity associated with the content item to the entity managing the content item selection server (e.g., ad server 104 in FIG. 1, etc.). The amount of the transferred funds may be determined in accordance with the various bid, distance and/or probability values discussed above, as well as upon other suitable factors including opportunity cost for the display of the content item. A portion of the transferred funds may be in turn directed to the owner of the publisher content that requested or otherwise resulted in the request for the content item. In some embodiments, funds may be transferred at the end of a pay period or on a basis different from a per-transaction basis (e.g. payment only happens once a certain number of users have converted in some way, such as by clicking an ad, otherwise no money changes hands).

As will be appreciated, network accessible devices can have different display characteristics and environments. The screen sizes and layout of publisher content in the context of mobile apps can be different from a traditional desktop/laptop/tablet format. Mobile ads served on a smart phone, for example, may be limited to a relatively small size which may nevertheless take up a relatively large portion of the available viewing area. Traditional ads served on a desktop display, on the other hand, can be larger and more interactive, and can in some cases be subject to greater conversion rates than mobile ads. Accordingly, without limitation the various embodiments disclosed herein can readily provide content items to “larger” displays associated with the user based on the geopositioning samples associated with a device of the user having a relatively “smaller” display.

In accordance with further embodiments, various different types of data, including but not limited to geoposition and time data, may be provided from the network accessible device 108 to generate a model generally indicative of one or more characteristics of the travel patterns of the device, which in turn may be correlated to the user carrying the device. The model may be based on position, velocity, acceleration, predicted destination, weather, map, device usage, and any other number of suitable types of data that may be provided in relation to the detected route(s) of the device 108. One or more content items may be provided for display on the display device, or on other devices associated with the user, responsive to the generated model.

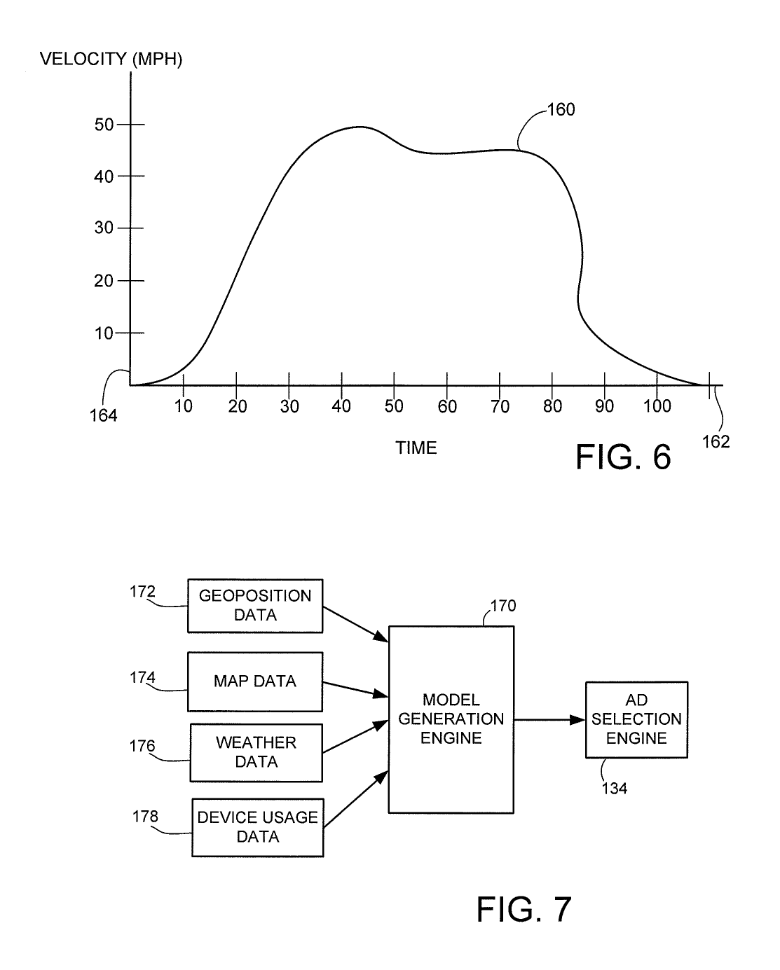

By way of illustration, FIG. 6 provides a velocity curve 160 plotted against an elapsed time x-axis 162 and a velocity (in miles per hour, mph) y-axis 164. The curve 160 may be associated with a selected one of the Routes A-D of FIG. 4, or a portion thereof, or with a different detected route, and is derived from a sequence of geoposition signals from the device as discussed above. The exemplary data are shown as a smooth curve, although it will be appreciated that the curve would likely be extrapolated from the discrete geopositioning samples discussed above in FIG. 3.

Depending on the resolution available from the geopositioning samples, characteristics associated with the curve 160 can be determined. For example, comparison of the maximum detected velocity to posted speed limits for the portion of the geographical route associated with the curve, as well as, when available, geopositional data from other devices proximate the device, may indicate whether the user of the device habitually drives faster or slower than the speed limit and/or the surrounding traffic. The rate of acceleration from a slower speed to a faster speed can similarly provide a measure of the aggressiveness of the manner in which the vehicle in which the device is located is driven. The user of the device is provided the opportunity to control whether programs or features collect such information. Thus, the user controls if and/or how information is collected about the user and used by a content server.

Over time, it may be determined that the user of the device is a member of a particular non-personally identifiable demographic, such as a young male, and this in turn may suggest certain opportunities regarding the display of content items, such as advertisements for the types of goods and/or services that might interest that demographic.

Filtering and other signal analysis may be applied to determine whether in fact the user of the device is the driver of the vehicle or is, instead, a passenger in the vehicle. This can be carried out, for example, by detecting usage of the device 108; a high rate of texting or other user interactive operations without significant deviations in the driven route may suggest the user of the device is a passenger. Measuring physical user input actions while the vehicle is performing maneuvers requiring driver attention (e.g., typing during a turn) is a sign that the device 108 is probably operated by a non-driver. The user of the device is provided the opportunity to control whether programs or features collect such information. Thus, the user controls if and/or how information is collected about the user and used by a content server.

Indeed, correlating the travel routes with usage and other information (such as public transit schedules) may enable the system to determine that the user of the device is travelling in a form of public transportation, such a municipal bus. This can also serve as a form of the model (e.g., the user of the device is a public transit participant for certain routes). It follows that the user is not necessarily free to deviate from the route, making it less attractive to serve ads for nearby establishments that would require the user to depart from the existing route at that time.

FIG. 7 depicts a model generation engine 170 in accordance with some embodiments. The engine 170 may be incorporated into the geo/time module 136 of FIGS. 2-3. The engine 170 uses a variety of data inputs, such as geoposition data 172, map data 174, weather data 176, device usage data 178, etc. to generate a model associated with the travel patterns of the device. The model can, in turn, be used as an input to the ad selection engine 134 in selecting an appropriate content item.

The geoposition data 172 can be provided as discussed above in FIG. 3. The map data 174 can include map information for streets, highways, terrain, etc. (e.g., Google Maps, NavTeq, Geographic Information Systems (GIS), Web GIS, etc.) in order to determine specific routes taken by the user of the network accessible device as well as information associated with such routes (e.g., posted speed limits, numbers of lanes, locations of exits and cross-streets, stop lights, etc.).

The weather data 176 may include one or more databases of stored and/or real-time weather information by time and location (e.g. NCDS, NWS, etc.). The device usage data 178 includes calls, email usage, texting, web-browsing, and other types of communication and usage data indicative of the usage of the device.

The model can be used in numerous applications to gain a better understanding of non-personally identifiable characteristics and interests of the user of the device. The model can take any variety of forms. For example, as noted above the speed normally driven along various routes and the acceleration/deceleration rates therealong can provide information that may indicate certain driving characteristics of the user. The inferred driving characteristics may in turn suggest a higher probability of user interest in various content items. The user of the device is provided the opportunity to control whether programs or features collect such information. Thus, the user controls if and/or how information is collected about the user and used by a content server.

High rates of acceleration and speed can suggest information regarding a user's ownership of, and/or interest in, high performance vehicles. A user (via the device geopositioning signals) who accelerates particularly fast on flat ground, but accelerates more slowly up slopes may be a potential candidate for certain types of goods/services, such as higher performance vehicles or engine modification/servicing.

Depending on the granularity of the geopositioning signals, a determination may be made that the user weaves from lane to lane with a regularly high frequency, which can also be used as a signal of aggressive driving. The user of the device is provided the opportunity to control whether programs or features collect such information. Thus, the user controls if and/or how information is collected about the user and used by a content server.

The weather data 176 can be combined with the above data to indicate whether the user tends to travel in areas subject to rain/snow/ice or other inclement conditions. Terrain information from the map data 174 can indicate the types of roads taken (e.g., main roads v. off-pavement routes). A user who frequently drives in such conditions may be identified as a candidate for ads and other content items for suitable goods/services relating to these conditions, such as snow tires, emergency kits, outdoor sporting goods, etc.

Comparing driving characteristics in good weather conditions as compared to inclement conditions can further characterize a level of risk-adverseness of the driver.

Models of a user's aggressiveness may be found to be a general predictor of demographics, and can inform decisions to advertise certain products such as beer, sports tickets, cars, etc. based on the predicted demographics.

Real-time monitoring of the geopositional samples can also suggest opportunities for appropriate content items in a push context. For example, if the device is determined to have come to a stop along a main thoroughfare, and other vehicles are detected as continuing on that same route, towing services or other emergency contact help messages may be automatically provided. Users that make multiple U-turns or very short stops can be provided ads related to GPS devices and other navigation aids.

While the embodiments discussed above are suitable for advertising (and other communications) to local consumers, the various techniques can be extended to a greater geographical range. The geopositional samples may indicate that the device 108 is being taken on an extended travel route, such as a cross-country trip, and therefore the model may suggest a vacation type travel pattern. Based on the time, speed and route taken, this may provide opportunities to extrapolate where the user may wind up being in the near future, such as near lunch time or at the end of the day. Suitable content items can be served for entities having physical locations, such as restaurants, lodging and entertainment attractions, near these areas based on the generated model.

The travel patterns are not necessarily limited to motorized vehicle based travel. Detected routes taken on a regular basis along jogging trails and/or bicycle paths, along with the associated velocity and acceleration data, may indicate the user is interested in physical fitness. Appropriate content items can be accordingly provided to the device 108 or other devices 108′ associated with the user.

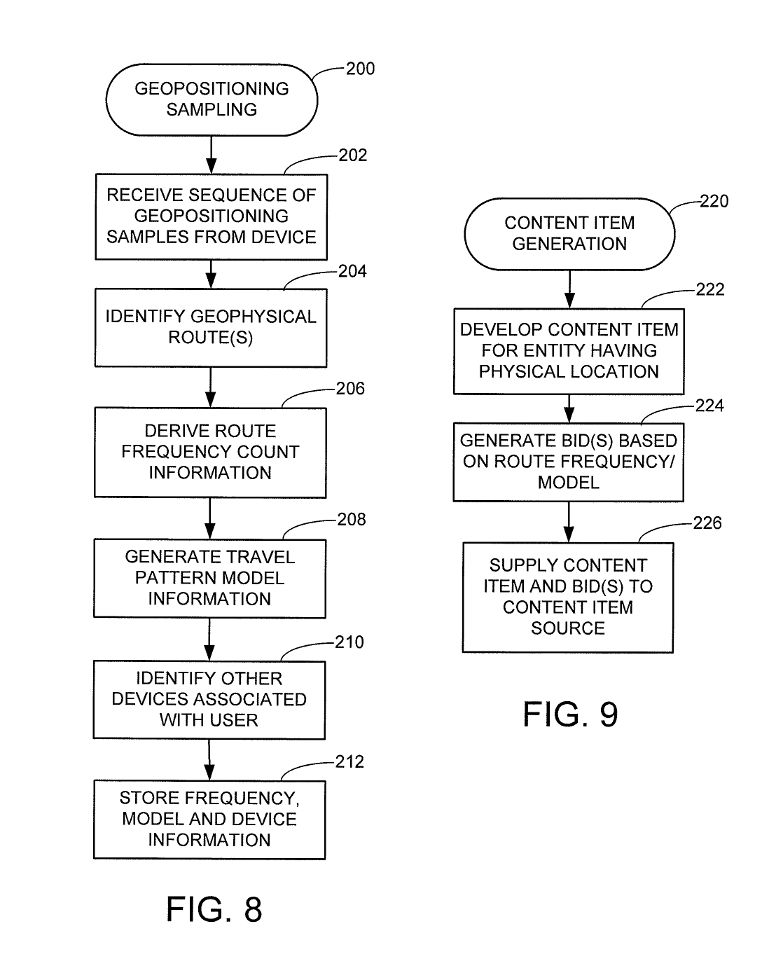

FIG. 8 sets forth a geopositioning sampling routine 200 generally illustrative of steps that may be carried out in accordance with some embodiments. A variety of alternatives have been discussed above, so that the various steps may be omitted, modified or appended as desired depending on the application. Generally, the routine 200 operates to identify travel patterns associated with a network accessible device, as carried out by the example geo/time detection module 136 of FIGS. 2-3.

A sequence of geopositioning samples from a network accessible device 108 is received at step 202. The samples are indicative of different geographical locations of the network accessible device over one or more time intervals.

At step 204, one or more geographical routes along which the device is repetitively moved are identified. This may include reference to map data and other forms of information to identify routes such as depicted in FIG. 4. Frequency information associated with the routes is derived at step 206. This frequency information may take a form as set forth in FIG. 5.

As desired, model information may be generated at step 208, providing one or more models indicative of characteristics of the travel patterns of the device along one or more of the routes of step 204. The model may be generated by the model generation engine 170 discussed above. Other user devices may be identified at step 210. This can be carried out as discussed above by requesting the user to identify other devices, by monitoring for access by the user to the system via various other devices, or via other suitable means. The frequency, model and device information are thereafter stored in a memory at step 212 for subsequent reference.

FIG. 9 depicts a content item generation routine 220. As before, the routine 220 is merely illustrative and various steps may be omitted, changed or added. Generally, the routine 220 operates to provide each of the available content items that may be selected responsive to the frequency/model/device information accumulated in the routine 200 of FIG. 8. The steps set forth in FIG. 9 may be carried out at the ad server 104 and advertiser 106 modules in FIGS. 1-2.

A content item is developed at step 222. The content item may be expressed as digital data stored in an associated memory, including programming code, graphics, audio/visual content, text, and any other suitable content. The content item will be associated with an entity and may be in the form of an advertisement or other form of promotional message, a communication, an invitation, a notification, etc. adapted for transmission to and display on a display device of a user.

It is contemplated albeit not necessarily required that the entity may have one or more physical locations, such as a retail establishment, in the general vicinity of the user of FIG. 8. For example, if the physical location is a restaurant, informational content associated with the content item may include a logo, a street address, walking directions, driving directions, a menu, a coupon, a special offer, a photograph, review or award information, etc. These and other elements of the content item can be displayed as desired.

One or more bids may be generated at step 224 for the content item of step 222. Each bid represents an amount the entity associated with the content item may be willing to pay to have the content item displayed on a user device. In some embodiments, multiple bids may be generated. For example, an entity may specify a first, lower bid for lower frequency routes and a second, higher bid for higher frequency routes. Different bids may also be provided for different proximities (distances) along a given route. For example, a relatively higher bid may be made for entities having physical locations located on or closely located to a high frequency route.

Different bids may further be generated based on the model information. Certain demographics may be selected, such as in the case of users inferred to be safe drivers, outdoors enthusiasts, etc. from the geopositional samples and model information.

At step 226, the generated bid(s) and content items are thereafter transferred for storage in a memory of a source of the content items, such as the ad server 104. In some embodiments, the entity generates the content item and the bids. In other embodiments, the ad server or a third party generates the content item and/or the bids. Different bids and content items may be grouped together into different ad campaigns.

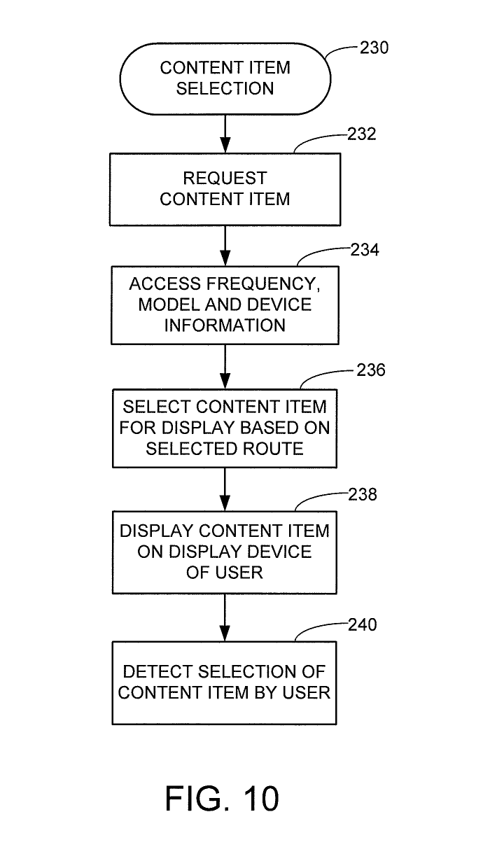

FIG. 10 shows a content item selection routine 230 in accordance with some embodiments. As before, various steps may be added, deleted and/or modified as desired. It is contemplated that the steps shown in FIG. 10 can be carried out by the ad server 104 in FIGS. 1-3.

A request for a content item is received from a device at step 232. It will be noted that the request may be an actual request or other communication signal from a network accessible device (e.g., 108, 108′ in FIG. 3) responsive to publisher content operative on the device. In a push context, for users who have previously elected to receive such content items, the request may be implied from the geopositional samples. This is illustrated, for example, in the case discussed above of the device being detected as being stationary along the side of a route that is otherwise determined to have moving traffic, and the system responds by providing a content item for emergency services to the device. In such case, the detected stationary position would constitute a request during step 232.

Responsive to the request, the system proceeds at step 234 to access the frequency/model/device information from the routine 200 of FIG. 8 for the associated user. A suitable content item is selected at step 236 from the population of available content items, each associated with a different entity that may have a physical location proximate the various geographical routes identified in the frequency/model/device information.

The content item may be selected using an automated auction or other suitable selection mechanism. The various bids may be factored into the selection process, with the content item having the highest expected return value, or highest probability of conversion, being selected. Any number of suitable parameters can be used in identifying the selected content item for display based on the above factors.

The selected content item is transferred for display on a device of the user at step 238. As noted above in FIG. 3, the device on which the content item is displayed may or may not be the same device from which the geopositional samples are received.

Selection of the content item is next detected at step 240. This can also be carried out in a variety of ways. In a traditional desktop environment, selection may be detected by the user clicking on the content item and sensing the provision of new content to the device. In a mobile device environment, selection may similarly be detected by the user interacting with the device by clicking the content item, shaking or otherwise manipulating the device, speaking a command to the device, etc.

Alternatively, selection of the content item in the context of a mobile device may involve detecting movement of the device away from a given route in a direction toward the physical location of the entity. Selection may further be confirmed by interaction of the device at the physical location, such as the scanning of a displayed bar code on the device (electronic coupon), by detecting the wifi hotspot, IP address, etc. of the physical location, etc. Upon selection, a transfer of funds may take place between the entity that provided the selected content item in FIG. 9 to the supplier of the content item (e.g., the ad server 104) in FIG. 10.

In situations in which the systems and/or methods discussed herein collect personal information about users, or may make use of personal information, the users may be provided with an opportunity to control whether programs or features collect user information (e.g., information about a user's social network, social action or activities, profession, a user's preferences, or a user's current location), or to control whether and/or how to receive content from the content server that may be more relevant to the user. In addition, certain data may be treated in one or more ways before it is stored or used, so that no personally identifiable information is removed. For example, a user's identity may be treated so that no personally identifiable information can be determined for the user, or a user's geographic location may be generalized where location information is obtained (such that the accuracy may be varied as to, e.g. by way of example, nearest ten (10) feet, a city, Zip code, or state level), so that a particular location of a user cannot be determined. Thus, the user may have control over how information is collected about the user and used by a content server.

In a further embodiment, the system can also include a request of a content item be provided from the population of available content items responsive to a loading of the selected publisher display. The content items which have been blocked are removed from the population of content items that can be displayed on the selected publisher display. A content item is now selected from the population of content items left after the selected content items have been blocked. The content item is then transferred to the device for display.

Implementations of the disclosure may be made in hardware, firmware, software, or any suitable combination thereof. Implementations of the disclosure may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the disclosure, and performing certain actions. However, it will be apparent that such descriptions are merely for convenience and that such actions in fact result from computing devices, processors, controllers, or other devices executing the firmware, software, routines, or instructions.

In accordance with the foregoing discussion, it will be understood that the “display” of a publisher display item on a graphical user interface (GUI) can be in any user detectable form, including but not limiting to visual, audible or other sensory form. Reference to “different types” of display items will be understood consistent with the foregoing discussion to describe different classes of display items that provide different file format displays for a user (e.g., text, audio, video, still images, mobile apps, etc.).

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A computer implemented method comprising:
receiving a sequence of geopositioning samples from a network accessible device indicative of different geographical locations of the device over a time interval;
identifying a geographical route along which the device was repetitively moved at least a threshold number N times during the time interval responsive to the sequence of geopositioning signals;
selecting a content item from a plurality of available content items each associated with a different entity having a physical location proximate the geographical route; and
displaying the content item on a display associated with a user of the network accessible device.

2. The method of claim 1, further comprising:
identifying a plurality of geographical routes along which the network accessible device was repetitively moved at least the threshold number N times over the time interval responsive to the sequence of geopositioning signals; and
accumulating a frequency count for each of the geographical routes indicative of a total number the device was moved along said route over the time interval, wherein the content item is selected based on the associated frequency count.

3. The method of claim 2, wherein the content item is selected based on the route having the greatest associated frequency count.

4. The method of claim 1, in which N is a plural number.

5. The method of claim 1, further comprising generating a model responsive to the geopositioning samples, acceleration data and timing data associated with the route, the model indicative of a characteristic associated with the route, wherein the content item is further selected in relation to the generated model.

6. The method of claim 5, in which the model is further generated responsive to map data associated with the route.

7. The method of claim 5, in which the model is further generated responsive to weather data associated with the route.

8. The method of claim 5, in which the model is further generated responsive to traffic data associated with the route.

9. The method of claim 1, in which the content item is further selected in relation to a bid provided by the entity indicative of an amount the entity is willing to pay for display of the selected content item, wherein the bid varies in relation to a total number of times the device is detected to have moved along the geographical route over the time interval.

10. The method of claim 1, wherein the network accessible device is a mobile communication device and the selected content item is displayed on a different, second network accessible device associated with the user of the mobile communication device.

11. The method of claim 10, in which the second network accessible device is a desktop computer of the user located proximate an end point of the geographical route.

12. The method of claim 1, further comprising detecting selection of the displayed content item by the user, and executing a transfer of funds between the entity and a source of the content item transferred to the display responsive to said selection.

13. The method of claim 12, wherein the selection of the displayed content item is detected by detecting a click of the displayed content item on the display.

14. The method of claim 12, wherein the selection of the displayed content item is detected by detecting movement of the network accessible device in a direction toward the physical location of the entity associated with the displayed content item within a predetermined selection response interval.

15. The method of claim 14, wherein the selection of the displayed content item is detected by detecting a wifi hotspot of the physical location of the entity associated with the displayed content item using the network accessible device.

16. The method of claim 1, further comprising generating a model of the user of the network associated device based on the geopositional samples, the model indicating a relative aggressiveness of the user as the user drives a motor vehicle, wherein the content item is selected in relation to the generated model.

17. The method of claim 1, in which the content item is an advertisement adapted for presentation in an ad slot of the selected display.

18. An apparatus comprising:
a geo/time detection module adapted to receive a sequence of geopositioning samples from a network accessible device indicative of different geographical locations of the device over a time interval, the module further adapted to identify a geographical route along which the device was repetitively moved by a user of the device during the time interval responsive to the sequence of geopositioning signals;
a model generation engine responsive to the geopositioning signals adapted to generate a model associated with a travel pattern of the geographical route; and
a content item selection engine adapted to select a content item from a population of available content items responsive to the geographical route and the generated model, and to transfer the content item for display on a display device associated with the user of the network accessible device.

19. The apparatus of claim 18, characterized as a server connected to the network accessible device over a network.

20. The apparatus of claim 18, in which the model is generated responsive to the geopositioning samples, acceleration data and timing data associated with the route, the model indicative of a characteristic manner in which the user drives a motor vehicle along the route, and the content item is selected responsive to said characteristic driving manner of the user.

21. The apparatus of claim 20, in which the model is further generated responsive to map data associated with the route.

22. The apparatus of claim 20, in which the model is further generated responsive to weather data associated with the route.

23. The apparatus of claim 20, in which the model is further generated responsive to traffic data associated with the route.

24. The apparatus of claim 18, in which the network accessible device is a mobile communication device and the selected content item is displayed on a different, second network accessible device associated with the user of the mobile communication device.

25. The apparatus of claim 24, in which the second network accessible device is a desk top computer of the user located proximate an end point of the geographical route.

26. The apparatus of claim 24, in which the model indicates whether the user travels as a passenger in a motor vehicle along the geographical route, and the content item is selected in response to said indication.

27. The apparatus of claim 18, in which the geo/time detection module is further adapted to detect a plurality of geographical routes along which the network accessible device was repetitively moved at least a threshold number N times over the time interval responsive to the sequence of geopositioning signals, and to establish a frequency count for each route indicative of a total number of times the route was travelled by the network accessible device during the time interval, and the selection engine further selects the content item in relation to the associated frequency count for the selected content item.

28. The apparatus of claim 18, in which the selected content item is an advertisement adapted for presentation in an ad slot of the display device.

29. The apparatus of claim 18, in which the content item is further selected in relation to a bid provided by the entity indicative of an amount the entity is willing to pay for display of the selected content item, wherein the bid has a magnitude that varies in relation to the generated model.

30. The apparatus of claim 29, in which the bid has a magnitude that varies in relation to a total number of times the device is detected to have moved along the geographical route over the time interval.

31. A computer-readable medium on which is stored programming adapted for execution by one or more processors to carry out steps comprising:
receiving a sequence of geopositioning samples from a network accessible device indicative of different geographical locations of the device over a time interval;
identifying a geographical route along which the device was repetitively moved responsive to the sequence of geopositioning signals;
generating a model indicative of a characteristic travel pattern associated with the geographical route;
selecting a content item from a plurality of available content items each associated with a different entity, the selected content item having content associated with the generated model; and
displaying the content item on a display associated with a user of the network accessible device.

32. The medium of claim 31, in which the network accessible device is a mobile communication device and the selected content item is displayed on a different, second network accessible device associated with the user of the mobile communication device.

33. The medium of claim 31, in which the second network accessible device is a desk top computer of the user located proximate an end point of the geographical route.

34. The medium of claim 31, in which the model indicates the user travels as a passenger in a motor vehicle along the geographical route, and the content item is selected in response to said indication.

35. The medium of claim 31, in which the model indicates the user travels as a driver of a motor vehicle along the geographical route, and the content item is selected in response to said indication.

36. The medium of claim 31, in which the model is further generated responsive to at least a selected one of map data, weather data, traffic data or usage data associated with the route.

37. The medium of claim 31, in which the programming is further adapted to detect a plurality of geographical routes along which the network accessible device was repetitively moved at least a threshold number N times over the time interval responsive to the sequence of geopositioning signals, to establish a frequency count for each route indicative of a total number of times the route was travelled by the network accessible device during the time interval, and to select the content item in relation to the associated frequency count for the selected content item.

38. The medium of claim 31, in which the selected content item is an advertisement adapted for presentation in an ad slot of the display device.

39. The medium of claim 31, in which the content item is further selected in relation to a bid provided by the entity indicative of an amount the entity is willing to pay for display of the selected content item, wherein the bid has a magnitude that varies in relation to the generated model.
